(19) United States
(12) Patent Application Publication
(10) Pub. No.: US 2024/0033712 A1
(43) Pub. Date: Feb. 1, 2024

(54) ABSORBENT FOR ACID GAS COMPRISING HYPERCROSSLINKED POLYMER

(71) Applicant: COMMONWEALTH SCIENTIFIC AND INDUSTRIAL RESEARCH ORGANISATION, ACTON (AU)

(72) Inventors: COLIN DAVID WOOD, KENSINGTON (AU); MATTHEW B MYERS, KENSINGTON (AU); CAMERON WHITE, KENSINGTON (AU)

(21) Appl. No.: 18/257,485

(22) PCT Filed: Dec. 22, 2021
(86) PCT No.: PCT/AU2021/051535

§ 371 Date: Jun. 14, 2023

(30) Foreign Application Priority Data
Dec. 22, 2020 (AU) 2020904794

(51) Int. Cl. B01J 20/26; B01D 53/62; B01D 53/82; B01J 20/28; B01J 20/30; B01D 53/96; B01J 20/34

(52) U.S. Cl. CPC B01J 20/267; B01D 53/62; B01D 53/82; B01J 20/28016; B01J 20/3085; B01D 53/96; B01J 20/3425; B01J 20/3483; B01D 2257/504; B01D 2253/202; B01D 2253/25; B01D 2258/06; B01D 2259/40088

(57) ABSTRACT

A composition for capture of acid gas comprising solid porous particles of hypercrosslinked polymer comprising a network of aryl groups linked by methylene (—CH2—) bridging groups formed by Friedel-Crafts catalyzed polymerization or Friedel-Crafts catalyzed post-polymerization cross-linking; wherein the solid porous particles of hypercrosslinked polymer contain absorbed liquid comprising an acid gas absorbent selected from chemical absorbent for acid gas, physical absorbent for acid gas or mixture thereof and the weight ratio of absorbed liquid to solid porous particles of hypercrosslinked polymer is from 1:1 to 5:1.

### FIELD

The present invention relates generally to a particulate composition for capturing acidic gases from, for example, a fluid stream, and more particularly to particulate compositions comprising a porous hypercrosslinked polymer and acid gas absorbent, and processes, methods, systems, uses, apparatus, and the like for the absorption of such acid gases from such a fluid stream.

### BACKGROUND

Acid gases such as carbon dioxide (CO₂), sulfur gases (e.g. SO₂, H₂S), and oxides of nitrogen (NOₓ), can cause significant environmental pollution and health risks. There has been increasing concern about the damage caused by these contaminants, which has led to an increased demand to reduce their emission, including CO_{2.}

Separation of acid gases, such as CO₂ and H₂S, from gas streams can be achieved via chemical absorption or chemical/physical absorption processes. The most widely used process for CO₂ separation and capture from acid gas-containing streams is the chemical absorption process utilizing liquid amine solutions. Aqueous solutions of monoethanolamine (MEA) or diethanolamine (DEA) are commonly used in the wet chemical absorption and low-pressure stripping of CO₂. In this process, the CO₂ reacts with the liquid amine solution to form a carbamate species. Upon heating, the carbamate species decomposes to release the absorbed CO₂ and regenerate the amine solution. This process can be costly and energy intensive. For example, the liquid amine solution has a limited life time due to its degradation through oxidation. Furthermore, the high corrosivity and viscosity of the utilized amine makes it difficult to use high concentrations of the amine solutions. Typically, only 10-30 wt % solutions of MEA are employed to capture CO₂ from the liquid amine solution has a limited life time due to its degradation through oxidation. The cyclic capture and release of acid gasses requires heating and cooling of large volumes of water.

Many amines used in capture of acid gases such as MEA solutions are also prone to oxidation by oxygen in the gas and can polymerize (with CO₂) at temperatures above 120° C. Degradation can contribute up to 10% of the total cost of the capture processes. Moreover, rapid heat transfer into acid gas capture materials can be limited. Therefore, methods to improve the thermal conductivity and stability of the acid gas capture materials are required.

Solid adsorbents such as amine-functionalized porous materials, zeolites, carbons and metal organic frameworks have been widely investigated for acid gas capture. In such materials, the porosity retained in the framework contains CO₂ absorbents or is functionalised with reactive groups to retain CO₂ uptake within the pores. Among these adsorbents, amine-functionalized porous materials have been most extensively investigated due to their ability to chemisorb low-concentration CO₂ from a gas stream. The adsorbents can be prepared by impregnating polymeric amines such as polyethyleneimine (PEI) into porous supports, by grafting aminosilanes on the pore surfaces or by in situ polymerization of amine monomers within the support. These materials also suffer with poor heat transfer, poor performance in the presence of water and limited thermo-chemical stability.

While porous polymers are potentially useful the level of absorption is typically limited by the need to maintain a balance between the porosity of the absorbent and an appropriate level of amine, so as to avoid clogging the pores and inhibiting gas contact with the internal pores.

Bai et al., “Polyethyleneimine (PEI)—impregnated resin absorbent with high efficiency and capacity for CO₂ capture from flue gas” New J. Chem., 2019, 43, 18345, reports a solid support based on microporous resins (pore sizes >50 nm) in which absorption efficiency is significantly reduced above a 50 wt % content of a high molecular weight polyamine absorbent that is absorbed without solvent into the pores of the resin.

There is a need for more effective compositions for capture of acid gas.

### SUMMARY

We have now found that certain porous hypercrosslinked polymers containing absorbed liquid that fills the pore space and swells the polymers are especially effective absorbents for capture of acid gas, notwithstanding the high loading of liquid in the available pore space of the polymers. The absorbed liquid comprises a chemical or physical acid gas absorbent or mixture thereof in a weight ratio of absorbed liquid to solid particles of hypercrosslinked polymer of from 1:1 to 5:1.

Accordingly, in a first aspect there is provided a composition for capture of acid gas comprising solid porous particles of hypercrosslinked polymer comprising a network of aryl groups linked by methylene (—CH₂—) bridging groups formed by Friedel-Crafts catalysed polymerization or Friedel-Crafts catalyzed post-polymerization cross-linking, wherein the solid porous particles of hypercrosslinked polymer contain absorbed liquid comprising an acid gas absorbent selected from chemical absorbent for acid gas, physical absorbent for acid gas or mixture thereof and the weight ratio of absorbed liquid to solid porous particles of hypercrosslinked polymer is from 1:1 to 5:1.

In some embodiments, the weight ratio of absorbed liquid to solid particles of hypercrosslinked polymer is from 2:1 to 5:1, such as from 2:1 to 4:1.

In some embodiments, the composition is in the form of a free-flowing powder.

In some embodiments, the hypercrosslinked polymer is selected from the group consisting of:
(i) a hypercrosslinked polymer of a substituted aryl monomer comprising at least two chloromethyl groups, formed by Friedel-Crafts catalysed polymerisation; and
(ii) a hypercrosslinked polymer formed by Friedel-Crafts catalyzed post-polymerization cross-linking of a polymer containing aryl monomers substituted by a chloromethyl group; and
(iii) a hypercrosslinked polymer formed by Friedel-Crafts catalyzed post-polymerization cross-linking of a polymer containing an aryl monomer with an external crosslinker.

In some embodiments, the hypercrosslinked polymer is formed by Friedel-Crafts catalyzed post-polymerization cross-linking of a polymer containing styrene with an external crosslinker, wherein the external cross-linker is selected from monochlorodimethyl ether and dimethyl formal.

In some embodiments, the hypercrosslinked polymer is a polymer of dichloroxylene, formed by Friedel-Crafts catalyzed polymerization.

In some embodiments, the hypercrosslinked polymer is hypercrosslinked polystyrene, formed by Friedel-Crafts catalyzed post-polymerization cross-linking of polystyrene.

In some embodiments, the absorbed liquid comprises at least 50 wt %, preferably at least 70 wt %, more preferably at least 80 wt %, most preferably at least 90 wt %, acid gas absorbent selected from physical absorbents for acid gas, chemical absorbents for acid gas and mixtures thereof.

In some embodiments, the absorbed liquid comprises a physical absorbent selected from the group consisting of methanol, dialkyl ether of polyethylene glycols, N-methyl-2-pyrrolidone, propylene carbonate, sulfolane, N-acetylmorpholine, N-formylmorpholine, alkanolpyridines and 1,3-dimethyl-3,4,5,6-tetrahydro-2(1H)-pyrimidinone.

In some embodiments, the acid gas absorbent comprises at least 50 wt %, preferably at least 70 wt %, more preferably at least 80 wt %, most preferably at least 90 wt %, chemical absorbent for acid gas selected from primary amines, secondary amines, tertiary amines and mixtures thereof.

In some embodiments, the acid gas absorbent is an amine selected from primary amines, secondary amines, tertiary amines and mixtures thereof. The amine may be selected from the group consisting of monoethanolamine, ethylenediamine, 2-amino-2-methyl-1-propanol, 2-amino-2-methyl-ethanolamine, benzylamine, aminomethylpyridine, N-methylethanolamine, piperazine, piperidine, substituted piperidine, 3-piperidinemethanol, 3-piperidine ethanol, 2-piperidinemethanol, 2-piperidineethanol, diethanolamine, diglycolamine, diisopropanolamine, N-methyldiethanolamine, N-piperidinemethanol, N-piperidine, N,N-dimethylaminoethanol and 3-quinuclidinol and combinations thereof. In some embodiments, the amine is one or more of monoethanolamine, diethanolamine and N-methyldiethanolamine.

In some embodiments, the absorbed liquid comprising acid gas absorbent is an amine which is a liquid at ambient temperature and pressure.

In some embodiments, the acid gas absorbent is a non-polymeric absorbent with a molecular weight of below 500 g/mol.

In some embodiments, the absorbed liquid comprising acid gas absorbent has a boiling point of at least 150° C.

In some embodiments, the solid porous particles of hypercrosslinked polymer containing absorbed liquid are of particle size (D50) of 0.1 micron to 1000 microns, preferably 50 microns to 500 microns.

In a second aspect there is provided a method for preparation of a composition for capture of acid gas comprising contacting a liquid comprising an acid gas absorbent selected from chemical absorbent for acid gas, physical absorbent for acid gas or mixture thereof with solid porous particles of hypercrosslinked polymer comprising a network of aryl groups linked by methylene (—CH₂—) bridging groups formed by Friedel-Crafts catalyzed polymerization or Friedel-Crafts catalyzed post-polymerization cross-linking to absorb the liquid into pores of the hypercrosslinked copolymer and form a free-flowing particulate composition, wherein the weight ratio of absorbed liquid to solid porous particles of hypercrosslinked polymer is from 1:1 to 5:1.

The liquid comprising an acid gas absorbent and the solid porous particles of hypercrosslinked polymer may generally be according to any embodiments disclosed herein in the context of the first aspect.

In a third aspect there is provided a method for removing acid gas from a gas mixture, the method comprising contacting the gas mixture with a composition for capture of acid gas according to any embodiment of the first aspect to absorb the acid gas into the absorbed liquid contained in pores of the solid porous particles of hypercrosslinked polymer.

In some embodiments, the gas mixture is selected from the group consisting of combustion flue gas, hydrocarbon gas mixture, emission from cement or steel production, biogas and ambient air.

In some embodiments, the method comprises: providing a housing comprising the composition; passing the gas mixture comprising an acid gas through the housing to absorb the acid gas into the absorbed liquid contained in pores of the solid porous particles of hypercrosslinked polymer; heating the composition to a temperature sufficient to desorb the acid gas from the solid porous particles; and flushing the desorbed acid gas from the housing.

In a fourth aspect there is provided an acid gas removal apparatus comprising a housing and a composition for capture of acid gas according to any embodiment of the first aspect, wherein the housing brings the gas mixture comprising acid gas into contact with the solid porous particles of hypercrosslinked polymer to absorb the acid gas into the absorbed liquid contained in pores of the solid porous particles of hypercrosslinked polymer.

In some embodiments, the housing comprises a packed bed or fluidized bed of the solid porous particles of hypercrosslinked polymer.

### BRIEF DESCRIPTION OF DRAWINGS

Various examples of the invention are described with reference to the attached drawings.

In the drawings:

FIG. 1 is a schematic drawing of the balloon apparatus used in examining acid gas absorption in the working examples.

FIG. 2 is a bar chart showing the CO₂ uptakes of various hypercrosslinked polystyrene (HCPS)/amine systems at 1:2 mass ratios

FIG. 3 is a graph including 5 plots showing CO₂ absorption curves for hypercrosslinked polystyrene/amine systems at 1:2 mass ratios.

FIG. 4 is a schematic diagrammatic showing the direct air capture (DAC) apparatus used in measuring acid gas absorption from direct air capture

FIG. 5 is a graph showing the DAC CO₂ uptake breakthrough curves for HCPS 100 wt % MEA particulate composition.

FIG. 6 is a graph showing the DAC CO₂ uptake breakthrough curve for HCPS 100 wt % DEA particulate composition.

FIGS. 7 is a graph showing the DSC heat curve for 100 wt % DEA HCPS particulate composition.

FIGS. 8 is a graph showing the DSC heat flow peaks/curves for 100 wt % DEA (FIGS. 7) and 100 wt % MEA HCPS particulate composition.

FIG. 9 depicts an apparatus for performing the method for capture of an acid gas from a gas mixture, according to some embodiments of the invention.

### DETAILED DESCRIPTION

In this specification the word “comprise” and variations of the word, such as “comprising” and “comprises” is not intended to exclude other additives, components, integers or steps.

The term “acid gas” means any one or more of carbon dioxide (CO₂), hydrogen sulfide (H₂S), carbon disulfide (CS₂), carbonyl sulfide (COS), mercaptans (R—SH, where R is an alkyl group having one to 20 carbon atoms), sulfur dioxide (SO₂), combinations thereof, mixtures thereof, and derivatives thereof. The particulate composition of the invention is particularly suitable for absorption of carbon dioxide and/or hydrogen sulphide from gas mixtures.

The term “physical absorbent” means an absorbent which absorbs the selected component from a feed gas stream by physical characteristics and not by means of a chemical reaction. Specific examples of physical absorbents include polyethylene glycols, alkyl ethers of polyethylene glycols and in particular dialkyl ethers such as dimethyl ethers of polyethylene glycol, N-methylpyrrolidone, propylene carbonate, sulfolane (tetrahydrothiophenedioxide) and estasolvan (tributyl phosphate). Specific examples of commercially available physical solvents include dimethyl ether (DEPG) of polyethylene glycol (UOP LLC; Des Plaines, IL) used in the SELEXOL process; methanol used in the RECTISOL® process (Lurgi AG; Frankfurt, Germany); RECTISOL® n-methyl-2-pyrrolidone (NMP) (Lurgi AG); and propylene carbonate (PC) used in the FLUOR SOLVENT process (Fluor Corp). The process using the physical solvent can extract hydrogen sulfide and carbon dioxide separately or simultaneously.

The term “chemical absorbent” means a chemical that preferentially absorbs to a selected component within a raw gas stream by means of a chemical reaction wherein a charge is transferred. Non-limiting examples include amines and potassium carbonate which may preferentially bond to H₂S or CO_{2.}

Examples of suitable amines include primary amines such as monoethanolamine, ethylenediamine, 2-amino-2-methylpropanol, 2-amino-2-methyl-ethanolamine and benzylamine; secondary amines such as N-methylethanolamine, piperazine, piperidine and substituted piperidine, N-alkyl derivatives of 2-amino-l-propanol (AP), especially 2-N-methylamino-l-propanol (MAP), 2-N-methylamino-2-methyl-l-propanol (MAMP), as well as derivatives with two or more hydroxyl groups and/or ether derivatives, diethanolamine, diglycolamine and diisopropanolamine; and tertiary amines such as N-methyldiethanolamine, and amino acids such as taurine, sarcosine, alanine, 2-amino-2-methyl-1-propanol (AMP), 3-piperidinemethanol, 3-piperidineethanol, 2-piperidinemethanol, 2-piperidineethanol, N-piperidinemethanol, N-piperidineethanol, 2-methylaminoethanol, N,N-dimethylaminoethanol and 3-quinuclidinol. monoethanolamine, diethanolamine, aminoethylethanolamine, diglycolamine, piperazine, N-aminoethylpiperazine, N-(2-hydroxyethyl)piperazine and morpholine.

Mixtures of chemical and physical absorbents include mixtures of alkanolamines and sulfolane such as diisopropanolamine (DIPA) and sulfolane, N-methyldiethanol-amine (MDEA) and sulfolane or at least one of MEA and DEA and sulfolane.

The term ‘particulate’ refers to the form of discrete solid units. The units may take the form of flakes, fibres, agglomerates, granules, powders, spheres, pulverized materials or the like, as well as combinations thereof. The particles may have any desired shape including, but not limited to, cubic, rod like, polyhedral, spherical or semi-spherical, rounded or semi-rounded, angular, irregular, and so forth.

The terms ambient temperature and ambient pressure refer to 20° C. and 1 atm respectively.

The invention provides a composition for capture of acid gas comprising solid porous particles of hypercrosslinked polymer comprising a network of aryl groups linked by methylene (—CH₂—) bridging groups formed by Friedel-Crafts catalyzed polymerization or Friedel-Crafts catalyzed post-polymerization cross-linking, wherein the solid porous particles of hypercrosslinked polymer contain absorbed liquid comprising an acid gas absorbent selected from chemical absorbent for acid gas, physical absorbent for acid gas or mixture thereof and the weight ratio of absorbed liquid to solid porous particles of hypercrosslinked polymer is from 1:1 to 5:1.

The composition is a particulate composition which is conveniently in the form of a dry, free-flowing powder, despite the high loading of absorbed liquid, because the absorbed liquid is contained inside the pores of the solid porous particles of hypercrosslinked polymer.

The remarkable uptake of the acid gas absorbent which includes at least an equal weight of absorbed acid gas absorbent is understood to be due to the significant swelling of the hypercrosslinked polymer particles in the presence of the acid gas absorbent. The dry state pore size of the hypercrosslinked polymer is in the low nanometer range, typically around 2 nm, so when the liquid swells into the polymer it is highly dispersed into molecular size ‘pockets’ which increases the contact area between the gas containing acid gas and the acid gas absorbent.

In preferred embodiments the weight ratio of absorbed liquid to solid porous particles of hypercrosslinked polymer is from 1.5:1 to 4:1, more preferably 2:1 to 4:1, such as 2:1 to 3.5:1 or 2:1 to 3:1.

Such a high loading of liquid acid gas absorbent has not been contemplated and is believed to result in part from the finding that the hypercrosslinked polymer swells in the presence of even hydrophilic liquid absorbents such as amines and alkanolamines for acid gas absorption to provide a content of acid gas absorbent which is not available for most solid particulate materials.

The capacity of the hypercrosslinked polymer for liquid comprising acid gas absorbent was not expected because:
1) we have found that hypercrosslinked polymers have a unique property of swelling in thermodynamically poor liquids capable of adsorbing acid gases, particularly amines which are particularly useful in reactive absorption of acid gas. The polymers are based on hydrophobic groups such as those found in polystyrene and although there were reports of swelling in some liquids, including water, hypercrosslinked polymers were not expected to swell in hydrophilic liquids capable of adsorbing acid gases; and
2) the use of this swelling characteristic was not expected to improve absorption of acid gas when the surface and pore structure of the hypercrosslinked polymers is substantially covered or even completely filled (i.e. blocked) with absorbed liquid.

We have found that despite the liquid absorbent taking up a substantial portion and in some cases all of the available pore volume of the hypercrosslinked polymer the performance of the composition is absorption and desorption of acid gas is very high.

The composition comprising the hypercrosslinked polymer and absorbed liquids is generally in the form of a dry, free-flowing powder and is therefore convenient to handle and transport with a high content of absorbed liquid. Advantageously, the composition remains in the form of a dry, free-flowing powder, i.e. without substantial escape of the absorbed liquid to the outside of the particles, even when acid gas is absorbed.

The composition includes a hypercrosslinked polymer comprising a network of aryl groups linked by methylene (—CH₂—) bridges formed by Friedel-Crafts catalyzed polymerization or Friedel-Crafts catalyzed post-polymerization cross-linking. Generally, the aryl groups are individual benzene rings linked by two or more bridges of single methylene groups (—CH₂—) to two or more other benzene rings. In one set of embodiments the methylene bridging groups form covalent links between two adjacent aryl groups to form a six membered carbocyclic ring that is attached to the aryl rings. The methylene bridge may provide a six membered ring between adjacent aryl groups to provide, for example, 9,10-dihydroanthracene structure where the aryl groups are substituted benzene.

Hypercrosslinked polystyrene (HCPS) was first synthesised in 1990 by Davankov and co-workers via Friedel-Crafts type reactions. HCPS (and other hypercrosslinked polymers) differ from porous organic polymers (POPs) due to their nano-porous nature, extremely high surface area and unique form of cross-linking (i.e. the bridges between phenyl rings). The ability of HCPS, and similar hypercrosslinked polymers comprising a network of aryl groups linked by methylene (—CH₂—) bridging groups, to swell while absorbing molecular liquids such as amines is thus not matched by other porous polymers. Synthetic strategies for the production of hypercrosslinked polymer comprising a network of aryl groups linked by methylene (—CH₂—) bridging groups are reviewed by Fontanals and colleagues in Polym. Chem., 2015, 6, 7231.

In some embodiments, the methylene (—CH₂—) bridging groups of the hypercrosslinked polymer are formed by Friedel-Crafts catalyzed polymerization. In some such embodiments the hypercrosslinked polymer particles are formed by Friedel-Crafts catalysed condensation polymerization of an aryl monomer in the form of benzene comprising at least two chloromethyl (—CH₂Cl—) substituents. In one example, the hypercrosslinked polymer is a polymer of dichloroxylene (e.g. para-dichloroxylene) formed by Friedel-Crafts catalyzed polymerization.

In a further embodiment the hypercrosslinked polymer is a polymer of a substituted aryl monomer comprising at least two chloromethyl groups, formed by Friedel-Crafts catalysed polymerisation.

In other embodiments, the methylene (—CH₂—) bridging groups of the hypercrosslinked polymer are formed in a Friedel-Crafts catalyzed post-polymerization cross-linking process. In some such embodiments the hypercrosslinked polymer is formed by post polymerisation crosslinking of polymers containing aryl monomers which are substituted with an internal electrophile, such as a chloromethyl group (—CH₂Cl—), capable of reacting with other aryl groups via a Friedel-Crafts catalyzed reaction to form bridging methylene groups. Examples of suitable aryl monomers which are substituted in this manner include optionally substituted vinylbenzyl chloride monomers. Such monomers can be polymerized, optionally together with other styrenic monomers, by conventional free radical polymerization to form vinylbenzyl chloride polymers, including homopolymers and copolymers such as vinylbenzyl chloride-co-divinylbenzene copolymers and vinylbenzyl chloride-co-styrene copolymers. The corresponding hypercrosslinked polymers are then formed by post-polymerization crosslinking of the polymers in the presence of a Lewis acid.

In other embodiments the hypercrosslinked polymer is formed by post polymerisation Friedel-Crafts catalysed crosslinking of polymers containing aryl monomers with an external crosslinker. Examples of suitable aryl monomers include optionally substituted styrene monomers and in particular styrene. Such monomers can be polymerized by conventional free radical polymerization to form polymers, including homopolymers and copolymers such as styrene-divinyl benzene copolymers and styrene-co-vinylbenzyl chloride copolymers. The external cross-linker may be any difunctional Friedel-Crafts cross-linking agent capable of forming a methylene bridges between aryl rings in the presence of a Lewis acid. Preferred examples include monochlorodimethyl ether and dimethyl formal.

In one specific embodiment the hypercrosslinked polymer comprises a polymer network having a structure, or structural component, of at least one of formula I and formula II:

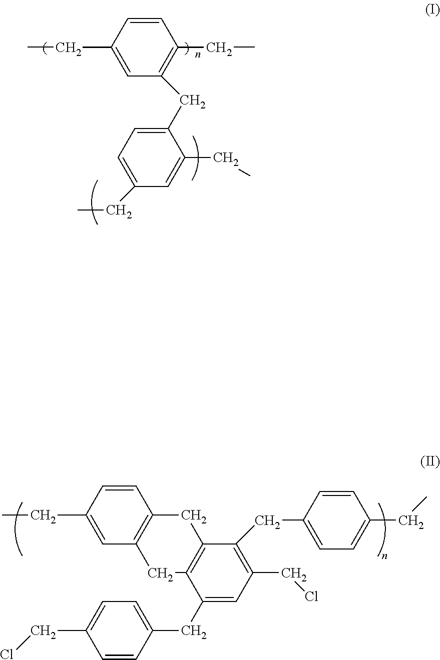

in which the number (n) of repeating units may be extremely high and indeed difficult to determine with accuracy.

The hypercrosslinked polymer particles used in the solid porous polymeric composition may be prepared in a range of particle sizes. Generally, the particles are of size (D50) of 20 nm to 5000 microns, particularly 0.1 microns to 2000 microns such as 0.1 micron to 1000 microns or 50 microns to 500 microns. The D50 particle size is defined such that 50 volume % of the particles is present in particles having a size less than the d50 particle size. The D50 particle size of a particulate composition may be measured by routine methods in materials science such as laser diffraction techniques or microscopy, in particular scanning electron microscopy (SEM) or transmission electron microscopy (TEM). It is also envisaged that the solid porous particles of hypercrosslinked polymer may be pelletized to increase the particle size. This may be preferred, for example, for packed bed column applications to mitigate pressure drop across the bed.

The pores of the porous hypercrosslinked polymer particles prior to absorption of liquid comprising the acid gas absorbent may have a median diameter of less than about 100 nm, and preferably less than 20 nm. In one embodiment, the pores can have a median diameter of about 0.10 nm to about 100 nm, with no particular distribution of shape or size required. The particularly preferred hypercrosslinked polymers particles have pore diameters of no more than about 5 nm and more preferably 2 nm (micropores).

The porous hypercrosslinked polymer prior to absorption of liquid comprising the acid gas absorbent has high surface area, for example greater than 500 m²/g, or greater than 700 m²/g. The surface area can be measured using N₂ adsorption with Brunauer-Emmett-Teller (BET) theory applied over the relative pressure range of 0.05 to 0.20 P/P₀ at 77 K.

The composition comprises an absorbed liquid comprising an acid gas absorbent selected from chemical absorbent for acid gas, physical absorbent for acid gas or mixture thereof. The acid gas absorbents are thus primarily or entirely liquid or dissolved components of the absorbed liquid present in the pores of the porous hypercrosslinked polymer and are not chemically grafted to the surfaces of the solid hypercrosslinked polymer. The compositions of the present disclosure are thus distinguished from those of U.S. Pat. No. 6,159,377, which teaches grafting of amines to residual chloromethyl-functionalities present on a porous polymer. In such a mode, the amines are chemically modified by the amination reactions (and thus less suited as acid gas absorbents) and high loadings of grafted amines cannot be achieved.

In some embodiments, at least 90 wt %, or substantially all, of the acid gas absorbent contained by the solid porous particles of hypercrosslinked polymer (that is, inside the pores) is present in the absorbed liquid, i.e. in the liquid phase and not chemically grafted to the hypercrosslinked polymer.

Preferred physical absorbents are solvents selected from the group consisting of methanol, dialkyl ether of polyethylene glycols, N-methyl-2-pyrrolidone, propylene carbonate, sulfolane, N-acetylmorpholine, N-formylmorpholine, alkanolpyridines (especially propanolpyridine) and 1,3-dimethyl-3,4,5,6-tetrahydro-2(1H)-pyrimidinone.

Generally, the preferred liquid comprising acid gas absorbent will comprise a chemical absorbent or mixture of physical and chemical absorbent. The absorbed acid gas absorbent preferably comprises an amine selected from primary amines, secondary amines, tertiary amines and mixtures thereof.

One of the significant advantages of the invention is that the absorbed liquid acid gas absorbent may comprise a high proportion of physical and/or chemical absorbent. For example, the absorbed liquid comprising acid gas absorbent may contain at least 50 wt %, preferably at least 60wt %, more preferably at least 70wt %, still more preferably at least 80 wt %, most preferably at least 90 wt % acid gas absorbent selected from physical absorbents for acid gas, chemical absorbents for acid gas and mixtures thereof. Indeed, the liquid absorbed into the hypercrosslinked polymer may be entirely acid gas absorbent selected from physical absorbents for acid gas, chemical absorbents for acid gas and mixtures thereof.

The acid gas absorbents are preferably non-polymeric molecules. It is challenging to load high amounts of polymeric acid gas absorbents, such as polyethyleneimine, into a hypercrosslinked polymer because such materials are either solids or high viscosity liquids. Moreover, the diffusion of acid gases into the particulate composition limits CO₂ absorption capacity even at relatively low loadings of a polymeric acid gas absorbent. In some embodiments, therefore, the molecular weight of the acid gas absorbents is less than 500 g/mol, preferably less than 200 g/mol.

In one embodiment the absorbed liquid comprising acid gas absorbent comprises at least 50 wt %, preferably at least 60 wt %, more preferably at least 70 wt %, more preferably at least 80 wt %, most preferably at least 90 wt % chemical absorbent for acid gas. The chemical absorbent for acid gas may be selected from primary amines, secondary amines, tertiary amines and mixtures thereof.

The preferred acid gas absorbents are amines or mixtures of amines and physical absorbents. Preferred amines may be selected from the group consisting of monoethanolamine, ethylenediamine, 2-amino-2-methyl-1-propanol, 2-amino-2-methyl-ethanolamine, benzylamine, aminomethylpyridine, N-methylethanolamine, piperazine, piperidine, substituted piperidine, 3-piperidinemethanol, 3-piperidine ethanol, 2-piperidinemethanol, 2-piperidineethanol, diethanolamine, diglycolamine, diisopropanolamine, N-methyldiethanolamine, N-piperidinemethanol, N-piperidine, N,N-dimethylaminoethanol and 3-quinuclidinol. The more preferred amines are monoethanolamine, diethanolamine and N-methyldiethanolamine.

The amines may be solid or liquid at ambient temperature and ambient pressure and where solid they can be dissolved in a suitable carrier liquid, which may itself be a chemical acid gas absorbent or physical acid gas absorbent, forming a component of the liquid absorbed into the hypercrosslinked polymer. It is particularly preferred, however that the acid gas absorbent, whether amine or otherwise, is selected from acid gas absorbents which are liquid at ambient temperature and ambient pressure.

In a further embodiment the liquid containing acid gas absorbent comprises at least 50 wt %, preferably at least 70 wt %, more preferably at least 80 wt %, most preferably at least 90 wt % of physical absorbents such as dialkyl ethers of polyethylene glycol (e.g. dimethyl ethers of polyethylene glycol), mixture of polyethylene glycol and dialkyl ethers, propylene carbonate, sulfolane, tributyl phosphate and mixtures thereof.

In a further embodiment the liquid containing acid gas absorbent comprises at least 50 wt %, preferably at least 70 wt %, more preferably at least 80 wt %, most preferably at least 90 wt %, such as at least 95 wt % of a mixture of chemical and physical absorbents such as mixtures of alkanolamines and sulfolane such as diisopropanolamine (DIPA) and sulfolane, N-methyldiethanol-amine (MDEA) and sulfolane or at least one of MEA and DEA and sulfolane.

The liquid containing acid gas absorbent comprising a physical absorbent, a chemical absorbent or mixture thereof is generally a liquid at ambient temperature and ambient pressure whether or not a solvent carrier such as water is also present.

It is particularly preferred that the liquid containing acid gas absorbent has low volatility such as a boiling point of at least 150° C.

In a further aspect the invention provides a method for preparation of the compositions disclosed herein. The method comprises contacting the liquid comprising acid gas absorbent with solid porous particles of hypercrosslinked polymer to absorb the liquid into the pores of the hypercrosslinked copolymer and form a free-flowing particulate composition.

The composition may be formed at a suitable temperature depending on the chemical and physical properties of the liquid and acid gas absorbents. In cases where the liquid to be absorbed is viscous it may be desirable to heat the liquid to reduce viscosity and facilitate more rapid absorption and/or a higher loading of the absorbed liquid in the polymer particles.

The liquid comprising acid gas absorbent that is contacted with the hypercrosslinked polymer preferably does not include a volatile solvent component which must be removed after absorbing the liquid into the pores. Such an approach makes it difficult to achieve the required high loadings of absorbed liquid in the solid porous particles of hypercrosslinked polymer because a significant portion of the pore space will initially be filled with the volatile solvent present in the loading fluid.

The acid gas absorbents present in the composition for capture of acid gas are in the liquid phase, and not chemically grafted to the hypercrosslinked polymer. Therefore, the hypercrosslinked polymer that is contacted with the liquid comprising acid gas absorbent typically has a low abundance of surface functionalities capable of reacting with the acid gas absorbent, such as amine-reactive functionalities. While it is not excluded that some residual reactive functionalities, such as chloromethyl groups, may remain after the polymer synthesis, any such functionalities are preferably present in amounts low enough relative to the acid gas absorbent that significant consumption of the acid gas absorbent does not occur.

In a further embodiment the invention provides a method for removing acid gas from a gas mixture, the method comprising contacting the gas mixture with the composition as disclosed herein to absorb the acid gas into the absorbed liquid contained in the pores of the solid porous particles of hypercrosslinked polymer.

Because the composition is typically a dry, free flowing powder, there is no bulk liquid phase present during the absorption. The gas mixture may thus be contacted with the solid porous particles of hypercrosslinked polymer in conventional gas-solid contact apparatus, such as a packed bed or fluidized bed of the particles.

The particles may be used in absorption of acid gas in a range of industrial processes such as in removing acid gas from pre-combustion processes such as from hydrocarbon gases, removal of acid gas from combustion gases, reducing acid gas produced in manufacture of products or the composition may be used in reducing the acid gas content of ambient air.

In one set of embodiments the gas mixture is selected from the group consisting of combustion flue gas, hydrocarbon gas mixture, emission from cement or steel production, biogas and ambient air.

The particulate composition may, in one set of embodiments, be introduced into a gas flowline as a flow of particulate material. The particulate composition can be provided in a packed bed with sufficient interstitial space between adjacent particles to allow a flow of gas therethrough.

The composition will typically be used to absorb acid gas by passing a gas mixture comprising the acid gas through a housing containing the composition particles. The acid gas is typically absorbed from a gas mixture at a temperature and can be recovered from the composition by changing the temperature and/or pressure, particularly by increasing the temperature.

Accordingly, in a further set of embodiments the invention provides a method for capture of an acid gas from a gas mixture comprising: providing a housing comprising the solid porous particles of hypercrosslinked polymer of the composition disclosed herein; passing the gas mixture comprising an acid gas through the housing to absorb acid gas into the absorbed liquid contained in the pores of the solid porous particles of hypercrosslinked polymer; heating the composition to a temperature sufficient to desorb the acid gas from the particles; and flushing the desorbed acid gas from the housing.

The acid gas may be absorbed into the pores of the hypercrosslinked polymer at a wide range of temperatures depending on the specific application and gas mixture. Generally speaking, the absorption of acid gas is carried out at a temperature of no more than 70° C. such as no more than 60° C. The acid gas may be desorbed from the particles by heating the particles for example using a heated gas stream. Typically, the particles will be heated to a temperature of at least 80° C. such as 80° C. to 110° C. or from 80° C. to 100° C. such as 80° C. to 95° C. or 80° C. to 90° C.

The heating of the particulate composition may be carried out using heated gas such as air, steam or using other heating methods such as thermal radiation or microwave heating. The desorbed acid gas may be flushed from the housing with a gas such as air, nitrogen or even recycled CO_{2.}

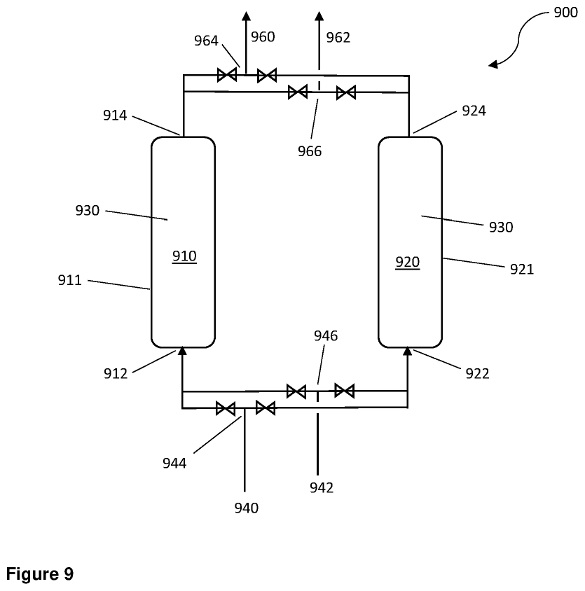

FIG. 9 depicts an apparatus 900 for performing the method for capture of an acid gas from a gas mixture, according to some embodiments of the invention. Apparatus 900 includes first column 910 comprising housing 911, gas inlet 912 and gas outlet 914, and second column 920 comprising housing 921, gas inlet 922 and gas outlet 924. The housing of each column is loaded with composition 930, for example as a packed bed or fluidized bed. Composition 930 is a dry, free flowing powder of solid porous particles of hypercrosslinked polymer which contain absorbed liquid comprising an acid gas absorbent as disclosed herein. Columns 910 and 920 are configured to be fed through their respective gas inlets with either gas mixture 940 or flush gas 942 via gas manifolds 944 and 946. The gas effluent exiting the columns via their respective gas outlets are directed to either transfer line 960, for acid gas lean gas, or transfer line 962, for acid gas enriched gas, via gas manifolds 964 and 966.

In use, gas mixture 940 is directed via manifolds 944, 946 to column 910 where it flows through housing 911 and contacts composition 930 therein. Gas mixture 140 may, for example, contain CO₂ as the acid gas to be captured. The acid gas is absorbed into the absorbed liquid contained in the pores of the solid porous particles of hypercrosslinked polymer. The gas effluent leaving column 910 is thus depleted of at least a portion of the acid gas, and is directed by gas manifolds 964, 966 to transfer line 960 which sends the acid gas lean gas (treated gas mixture 940) for further processing or atmospheric release.

After a period of time, the absorption capacity of composition 930 in column 910 will approach its maximum and the material must be regenerated to avoid unacceptable breakthrough of the acid gas. Therefore, gas mixture 940 is redirected via manifolds 944, 946 to column 920 where it flows through housing 921 and contacts composition 930 therein. The gas effluent leaving column 920 is thus depleted of at least a portion of the acid gas, and is directed by gas manifolds 964, 966 to transfer line 960.

While gas mixture 940 is being processed in column 920, the composition 930 in column 910 is regenerated by heating the composition to a temperature sufficient to desorb the acid gas from the solid porous particles of hypercrosslinked polymer. The desorbed acid gas is then flushed from housing 911 of column 910 with flush gas 942. The composition may be heated with flush gas 952, which is fed for contact with the composition at a suitably high temperature and/or by other conventional means of heating a particulate composition in a column. The gas effluent leaving column 910 is thus rich in acid gas, and is directed by gas manifolds 964, 966 to transfer line 962 which sends the acid gas enriched gas for storage or further processing. By switching the columns sequentially between absorption and desorption modes in this manner, acid gas 940 can be continuously processed to capture all or part of the acid gas therefrom.

The invention thus also provides an acid gas removal apparatus comprising a housing and the composition for capture of acid gas disclosed herein, wherein the housing brings the gas mixture comprising acid gas into contact with the solid porous particles of hypercrosslinked polymer to absorb the acid gas into the absorbed liquid contained in pores of the solid porous particles of hypercrosslinked polymer.

The acid gas removal apparatus may comprise a packed bed or fluidized bed of the particles.

The invention will now be described with reference to the following examples. It is to be understood that the examples are provided by way of illustration of the invention and that they are in no way limiting to the scope of the invention.

### EXAMPLES

### Example 1, Part A—Preparation of Hypercrosslinked Polymer from p-DCX.

To a solution of para-dichloroxylene (a,a′-dichloro-p-xylene; p-DCX) monomer (0.171 mol, 30 g) in anhydrous 1,2-dichloroethane (DCE) (388 mL), a DCE solution (388 mL) of FeCl₃ (0.173 mol, 28 g) was added. The resulting mixture was stirred in an open vessel at room temperature. The precipitated p-DCX hypercrosslinked polymer was washed once with water, three times with methanol (until the filtrate was clear), and with diethyl ether followed by drying for 24 h at 60° C. The particles are then sieved to a particular size, typically in the range of 20 nm to 5000 microns, particularly 0.1 microns to 2000 microns such as micron to 1000 microns or 50 microns to 500 microns

### Example 1, Part B—Preparation of Particulate Acid Gas Absorbent.

The material was prepared by combining 0.3 g of HCP of Example 1 Part A with 1 g of MEA and mixing at room temp until MEA was fully absorbed by the HCP (approx. 15 mins) to form a free-flowing powder with a particle size (D50) of about 200 microns before absorption of the liquid and about 250 microns following absorption of liquid. The particles sizes were determined by light scattering and microscopy. The absorption of the liquid thus caused significant swelling of the HCP particles.

### Example 1, Part C—Acid Gas Absorption/Desorption.

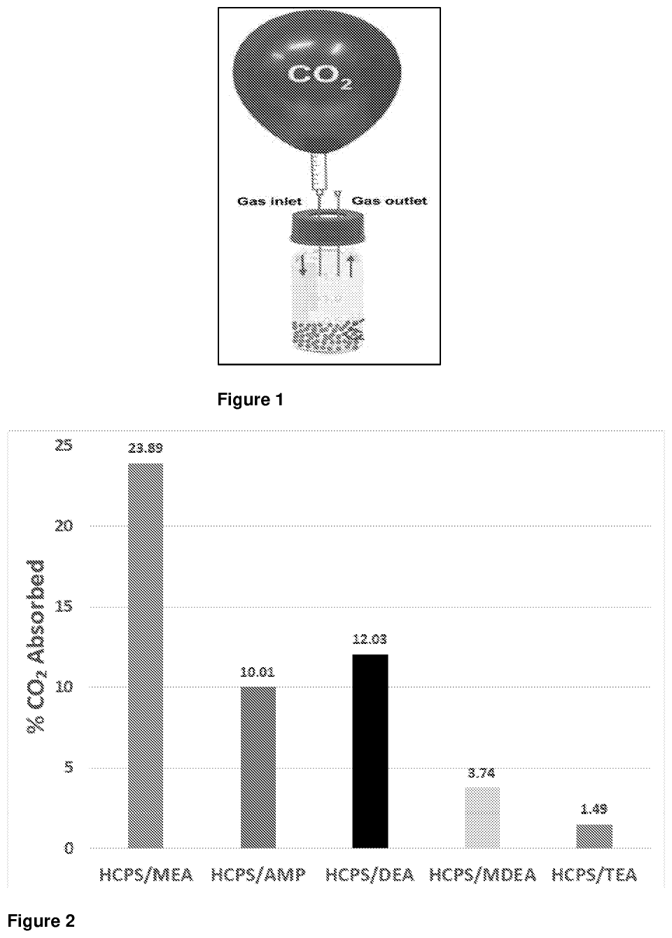

After swelling, the mass of the vial and swollen polymer system was taken as a baseline value. CO₂ was injected into the vial via a balloon with a needle and a second needle to act as a purge vent as shown in FIG. 1. After one minute of venting the needles were removed, the vial was weighed and the first needle was reintroduced to pressurise the vial, allowing the system to absorb CO₂. The vial was then weighed every 5 minutes thereafter until mass changed plateaued, indicating maximal CO₂ absorption capacity had been achieved and the system was “CO₂ saturated”. This was conducted at ambient temperatures and the balloon was refilled as it became depleted to maintain relatively consistent pressure throughout.

A rubber septum was then inserted into the top of the vial and the total mass was measured. A “vent needle” was then inserted into this septum. Another syringe attached to a balloon filled with CO₂ was then inserted into the septum allowing CO₂ to flow through the vial. After 1 min the vent needle was removed, and the vial/septum filled with material was weighed again. The syringe attached to the CO₂ balloon was then reinserted allowing the CO₂ to pressurise the vial and allowing the material to absorb CO₂. The total mass of the vial/material/septum was then measured every 5 mins for an hour, followed by every hour until the mass change had plateaued. The balloon was refilled with CO₂ every 10 mins to allow for a constant pressure throughout the experiment.

To desorb the CO₂ the rubber septum was removed from the vial and the mass of the vial/material was measured before being placed in an oven at 80° C. The vial was left in the oven until the mass of the vial/material was equal to or below the starting mass, indicating the absorbed CO₂ had been removed (approx. 3.5 hours).

Total mass before desorption=15.6229 g

Total mass after desorption=15.3040 g

The proportions of components are detailed in Table 1.

| mass of | mass of | | mass of | mol | mol | Amine |
|---|---|---|---|---|---|---|
| HCP/MEA | CO2 | % CO2 | MEA | MEA | CO2 | Loading |
| (g) | abs (g) | Abs | used (g) | used | abs | (mol/mol) |
| 1.3064 | 0.3125 | 23.92 | 1.0056 | 0.0165 | 0.0071 | 0.43 |

### Example 2, Part A—Hypercrosslinked Polystyrene (HCPS) Synthesis.

The following synthesis was adapted from Fu and co-workers' 2017 synthesis. [Fu, Z.; Jia, J.; Li, J.; Liu, C., Transforming waste expanded polystyrene foam into hyper-crosslinked polymers for carbon dioxide capture and separation. Chemical Engineering Journal 2017, 323, 557-564]. Polystyrene (30 g, MW = 260,000, 0.115 mmol) was dissolved in formaldehyde dimethylacetal (90 ml, 1.02 mol) and 1,2-dichloroethane (400 ml, 5.05 mol). Once dissolved the polystyrene solution was added to another flask containing iron(III) chloride (125 g, 0.77 mol). The reaction was left for 72 h to complete with mechanical stirring. After completion the mixture was vacuum filtered and washed with methanol (6 × 300 ml), 10% aqueous hydrochloric acid (6 × 300 ml), methanol (3 × 300 ml), acetone (1 × 300 ml) and dichloromethane (1 × 300 ml), at which point the filtrate was colourless. The resulting orange powder was air dried for 72 h, followed by drying at 60° C. in a vacuum oven for 24 h.

Porosity and surface area values of the hyper-crosslinked polystyrene were measured by an ASAP 2020 (Micromeritics) gas adsorption analyser. The hyper-crosslinked polystyrene powder was degassed by heating the sample at 1° C./min rate to 99° C. and evacuation of the chamber to 10 Pa. The conditions were held for 200 min; then heated to 120° C./min rate and held for 900 min prior to measurements. Surface areas were calculated using N₂ adsorption with Brunauer-Emmett-Teller (BET) theory and Langmuir theory applied over the relative pressure range of 0.05 to 0.20 P/P₀ at 77 K. BET and Langmuir theory calculations yielded surface areas of 795 and 1090 m²/g.

A general scheme for this hypercrosslinked polystyrene (HCPS) synthesis is shown below:

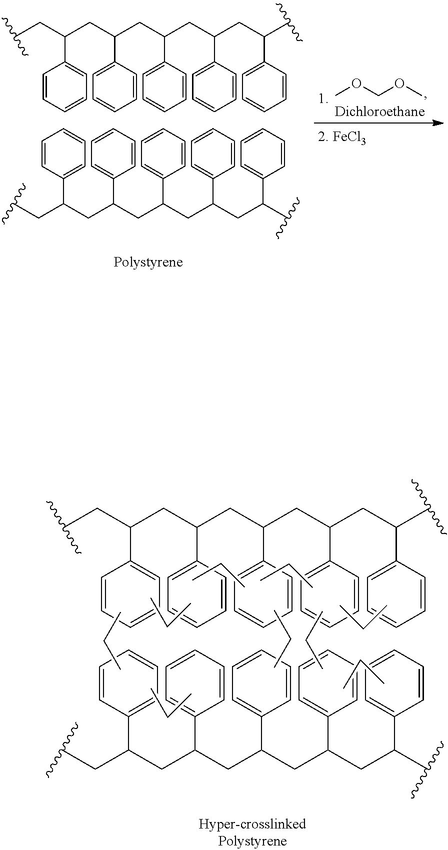

### Example 2, Part B—Amine-Solvent Mixture Preparations.

To prepare solvent mixtures the specified amine was mixed at room temperature with the specified solvent at the specified wt % to provide a homogeneous mixture.

### Example 2, Part C—Swelling Experiments and “Successful Swelling” Screening.

For every system, based on a specified amine-solvent mixture and/or pure amine, the polymer prepared in Example 2, Part A was swelled by combining 1 ml of the amine-solvent mixture/amine with 0.5 g, 0.3 g, 0.25 g and 0.2 g of the specified polymer in a vial to achieve polymer to solvent ratios of 1:2, 1:3, 1:4 and 1:5 respectively. These were then swelled at the specified temperature in an oven, for the specified amount of time. HCPS systems were considered successfully swelled when there was no liquid present and the resulting material was powdery and free-flowing (i.e. material did not clump together).

### Example 2, Part D—Examples of Solvent Swelled HCP Systems.

The following systems were swelled into HCPS. Successful swelling occurred at a 1:2 (polymer:solvent) weight ratio. Swelling was done at room temperature with mixing for 15 min.

TABLE 2
Swelling capabilities of various amines
in HCPS at a 1:2 ratio (polymer:amine).

| | Successfully |
|---|---|
| Solvent System | swelled? |
| 100 wt % MEA | Yes |
| 100 wt % AMP | Yes |
| 100 wt % DEA | Yes |
| 100 wt % MDEA | Yes |
| 100 wt % TEA | Yes |

### Example 3—CO₂ Absorption.

Pure amine absorbent systems were tested with the HCPS as support. The amines were absorbed onto the HCPS in a ratio of 1:2 (polymer:solvent), as shown in Table 2, by simply mixing the two components. Ethylenediaminetetraacetic acid (EDTA) or Na₃PO₄ (2 wt. % (of the liquid amine) was added in some cases as a chelator for any residual iron ions that might catalyse amine oxidation.

Industrial CO₂ (BOC, >99.9% purity) was flowed through a vial (containing the desired amine-infused HCP-PS powder, typically approximately 1 gram of sorbent) via a needle through a septum with a second needle used to vent the vial. At specific time intervals, the needles were quickly removed, the vial was weighed and then the needles were replaced. This process is repeated until the mass change plateaus, indicating that the sorbent was fully saturated with CO₂. All pure CO₂ experiments were conducted at room temperature. With the exception of the tertiary amines that were tested, all of the systems displayed exceptional CO₂ uptake and uptake kinetics.

As seen in FIG. 2, HCPS/MEA displayed the highest CO₂ uptake of 23.89%, followed by 12.03%, 10.01%, 3.74% and 1.49% for HCPS/DEA, HCPS/AMP, HCPS/MDEA and HCPS/TEA respectively. These correlate to amine loadings of 0.49, 0.3, 0.43, 0.15 and 0.08 mols CO₂ per mol of amine for the MEA, DEA, AMP, MDEA and TEA systems respectively. This is particularly exciting for HCPS/MEA and HCPS/DEA systems as their uptakes approach the theoretical maximum of 0.5 mol CO₂ per mol amine (24.14% for HCPS/MEA and 13.73% for HCPS/DEA).

The high CO₂ uptakes of HCPS/MEA and HCPS/DEA can be attributed to their high reactivity and lower viscosities, which greatly enhance CO₂ diffusion and uptake within the system. HCPS/AMP, despite containing a theoretically more reactive primary amine similar to HCPS/MEA, absorbed less than HCPS/DEA. This is due to steric hindrance from the methyl groups in AMP, which would have reduced the amine's ability to react with CO_{2.}

Conversely the high viscosities and low reactivities of the tertiary amines in HCPS/MDEA and HCPS/TEA resulted in low uptakes. The solubility of the (bi) carbonates formed by the reaction between MDEA/TEA and CO₂ may also inhibit CO₂ uptake. The HCPS/DEA, HCPS/MDEA and HCPS/TEA systems all absorbed unexpectedly high levels of CO₂ compared with other porous absorbent supports.

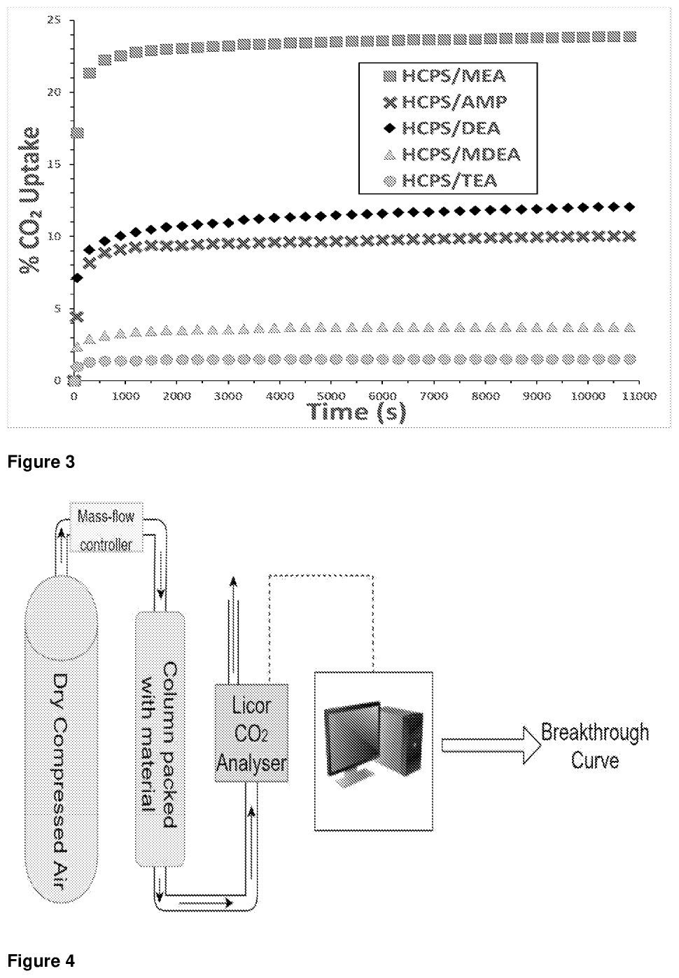

The benefit of the higher surface area granted to the amines by the HCPS is best exemplified in the absorption curves and absorption times (Approximate time taken to reach 90% of maximum CO₂ uptake for HCPS systems is shown in Table 3 FIG. 3 includes 5 plots showing CO₂ absorption curves for HCPS systems). The rapid uptake of CO₂ by MEA and AMP can also be attributed to their high reactivity as primary amines. The DEA, MDEA and TEA HCPS systems, however, absorbed CO₂ very rapidly despite the significant quantity of absorbed liquid.

TABLE 3
Approximate time taken to reach 90% of
maximum CO₂ uptake for HCPS systems.

| | Approx. time to |
|---|---|
| System | 90% uptake (min) |
| HCPS/MEA | 10 |
| HCPS/AMP | 15 |
| HCPS/DEA | 45 |
| HCPS/MDEA | 20 |
| HCPS/TEA | 15 |

HCPS/MDEA and HCPS/TEA appear to absorb CO₂ quicker than HCPS/DEA despite their greater viscosity and lower reactivity. This is likely due to their lower maximum uptakes as HCPS/DEA absorbs more CO₂ in the same timeframe, indicating it is more kinetically favoured.

### Example 4 Direct Air Capture (DAC) Capabilities.

To perform DAC experiments, a stream of air was passed through a column packed with the specified material (5-15 g depending on the material) at a known flow rate of 500 ml per minute using a thermal mass flow controller (Bronkhorst EL-Select). The CO₂ concentration in this air stream was measured using a Licor Li-840a inline CO₂ analyser. By plotting this with regard to time and integrating the resulting breakthrough curve, the CO₂ uptake of the material can be determined. A diagrammatic representation of this process is shown below, in which gas flow is represented by the arrow. FIG. 4 shows a diagrammatic representation of DAC apparatus.

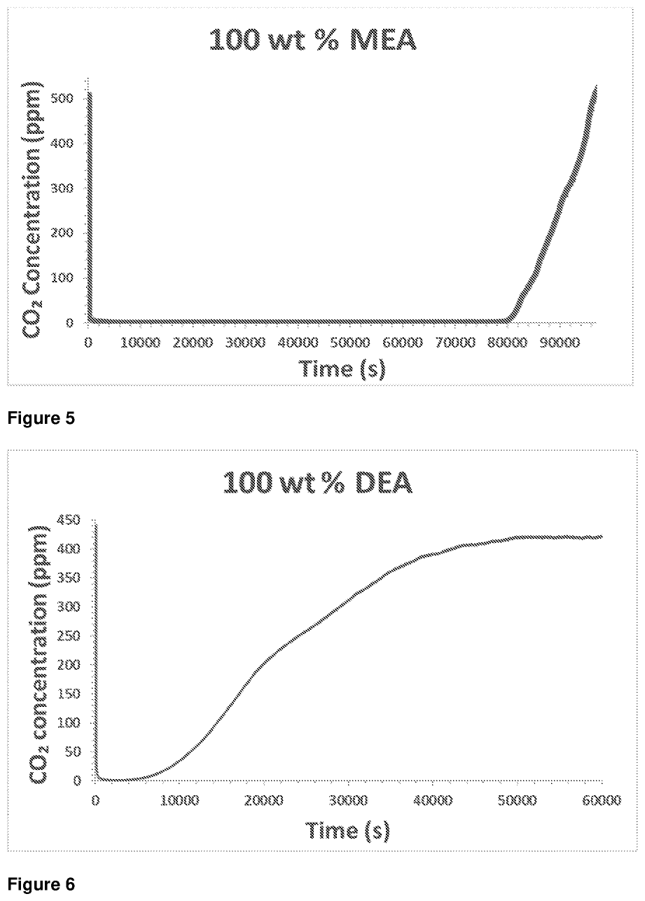

Given their high pure CO₂ uptake capabilities, the HCPS/MEA and HCPS/DEA systems were then tested under direct air capture conditions. Under these conditions the HCPS/MEA system displayed a CO₂ uptake of 13.5% and the HCPS/DEA system displayed a CO₂ uptake of 2.92%. The breakthrough curves for these can be seen in FIGS. 5 and 6 which plot DAC CO₂ uptake breakthrough curves for HCPS 100 wt % MEA (FIGS. 5) and 100 wt % DEA (FIG. 6) systems.

The difference between pure CO₂ uptake and DAC uptake is again due to the differing CO₂ concentrations in these experiments. The difference between MEA and DEA systems is due to their differing reactivities, with MEA being more reactive and therefore absorbing more CO_{2.}

### Example 5—DSC Analysis.

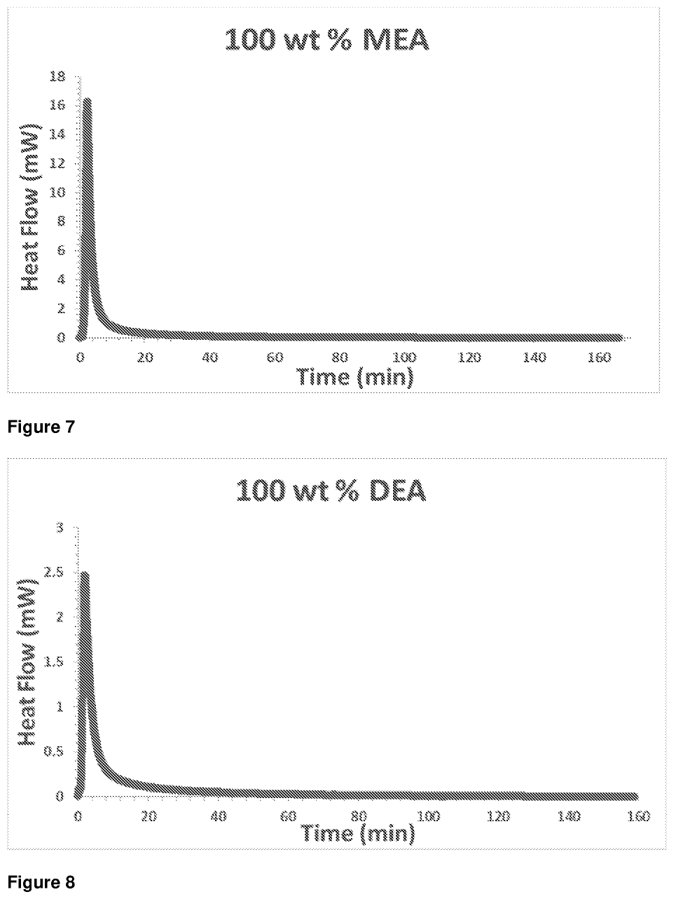

The heat of absorption of CO₂ was then determined for the HCPS/MEA and HCPS/DEA systems. FIGS. 7 and 8 show the DSC heat flow peaks/curves for 100 wt % DEA (FIGS. 7) and 100 wt % MEA (FIG. 8) HCPS systems. By integrating these peaks, the heat of adsorptions of CO₂ were determined to be 1707 J/g CO₂ (75.14 kJ/mol) for HCPS/MEA and 1316 J/g CO₂ (57.9 kJ/mol) for HCPS/DEA.

HCPS/MEA has a higher heat of adsorption due to MEA being a primary amine and having a higher affinity towards CO₂ than DEA.

### Example 6—Loading of Polymeric Amine Absorbent on Hypercross-Linked Polymer (Comparative)

Hypercrosslinked polystyrene (HCPS as prepared in Example 2) was mixed with polyethyleneimine (PEI) Mw 25K at a ratio of 1:1 or 1:2 (HCP:PEI). A sticky film was formed in each case and not a free-flowing powder, and it is apparent that the HCPS could not take up the PEI into its internal porosity. The pure CO₂ uptake of this film was measured and it was <0.5% by weight uptake which is a strong indication that the liquid was not swelled into the HCP.

### Example 7— Loading of Diethanolamine onto Alternative Porous Supports (Comparative)

Attempts were made to load liquid amines, in particular diethanolamine (DEA), into silica and activated carbon (AC) porous sorbents. In one representative example, DEA was mixed with activated carbon at a ratio of 1:2 (AC:DEA). A liquid film of DEA loaded with AC was generated, and not the desired free flowing powder. The same was obtained with silica. In both cases, the liquid loading relies on filling the pore space and not swelling the support, therefore, excess liquid remains outside the support material thus forming a film and not a free-flowing powder. The CO₂ uptake for these films were <1% because the liquid film had low contact with the gas.

Finally, it is to be understood that various other modifications and/or alterations may be made without departing from the spirit of the present invention as outlined herein.

1. A composition for capture of acid gas comprising solid porous particles of hypercrosslinked polymer comprising a network of aryl groups linked by methylene (—CH₂—) bridging groups formed by Friedel-Crafts catalyzed polymerization or Friedel-Crafts catalyzed post-polymerization cross-linking; wherein the solid porous particles of hypercrosslinked polymer contain absorbed liquid comprising an acid gas absorbent selected from chemical absorbent for acid gas, physical absorbent for acid gas or mixture thereof and the weight ratio of absorbed liquid to solid porous particles of hypercrosslinked polymer is from 1:1 to 5:1.

2. The composition of claim 1 wherein the weight ratio of absorbed liquid to solid particles of hypercrosslinked polymer is from 2:1 to 5:1 or from 2:1 to 4:1.

3. (canceled)

4. The composition of claim 1 in the form of a free-flowing powder.

5. The composition of claim 1, wherein the hypercrosslinked polymer is selected from the group consisting of:
(i) a hypercrosslinked polymer of a substituted aryl monomer comprising at least two chloromethyl groups, formed by Friedel-Crafts catalysed polymerisation;
(ii) a hypercrosslinked polymer formed by Friedel-Crafts catalyzed post-polymerization cross-linking of a polymer containing aryl monomers substituted by a chloromethyl group; and
(iii) a hypercrosslinked polymer formed by Friedel-Crafts catalyzed post-polymerization cross-linking of a polymer containing an aryl monomer with an external crosslinker.

6. The composition of claim 1, wherein the hypercrosslinked polymer is selected from the group consisting of:
(i) a hypercrosslinked polymer formed by Friedel-Crafts catalyzed post-polymerization cross-linking of a polymer containing styrene with an external crosslinker, wherein the external cross-linker is selected from monochlorodimethyl ether and dimethyl formal;
(ii) a polymer of dichloroxylene, formed by Friedel-Crafts catalyzed polymerization; and
(iii) hypercrosslinked polystyrene, formed by Friedel-Crafts catalyzed post-polymerization cross-linking of polystyrene.

7.-8. (canceled)

9. The composition of claim 1, wherein the absorbed liquid comprises: at least 50 wt % acid gas absorbent selected from physical absorbents for acid gas, chemical absorbents for acid gas and mixtures thereof, and/or at least 50 wt % chemical absorbent for acid gas selected from primary amines, secondary amines, tertiary amines and mixtures thereof.

10. The composition of claim 1, wherein the absorbed liquid comprises a physical absorbent selected from the group consisting of methanol, dialkyl ether of polyethylene glycols, N-methyl-2-pyrrolidone, propylene carbonate, sulfolane, N-acetylmorpholine, N-formylmorpholine, alkanolpyridines and 1,3-dimethyl-3,4,5,6-tetrahydro-2(1H)-pyrimidinone.

11. (canceled)

12. The composition of claim 1, wherein the acid gas absorbent is an amine selected from primary amines, secondary amines, tertiary amines and mixtures thereof.

13. The composition of claim 12, wherein the amine is selected from the group consisting of monoethanolamine, ethylenediamine, 2-amino-2-methyl-1-propanol, 2-amino-2-methyl-ethanolamine, benzylamine, aminomethylpyridine, N-methylethanolamine, piperazine, piperidine, substituted piperidine, 3-piperidinemethanol, 3-piperidine ethanol, 2-piperidinemethanol, 2-piperidineethanol, diethanolamine, diglycolamine, diisopropanolamine, N-methyldiethanolamine, N-piperidinemethanol, N-piperidine, N,N-dimethylaminoethanol and 3-quinuclidinol and combinations thereof.

14. The composition of claim 12, wherein the amine is one or more of monoethanolamine, diethanolamine and N-methyldiethanolamine.

15. The composition of claim 12, wherein the absorbed liquid comprising acid gas absorbent is an amine which is a liquid at ambient temperature and pressure.

16. The composition of claim 1, wherein the acid gas absorbent is a non-polymeric absorbent with a molecular weight of below 500 g/mol.

17. The composition of claim 1, wherein the absorbed liquid comprising acid gas absorbent has a boiling point of at least 150° C.

18. The composition of claim 1, wherein the solid porous particles of hypercrosslinked polymer containing absorbed liquid are of particle size (D50) of 50 microns to 500 microns.

19. A method for preparation of a composition for capture of acid gas comprising contacting a liquid comprising an acid gas absorbent selected from chemical absorbent for acid gas, physical absorbent for acid gas or mixture thereof with solid porous particles of hypercrosslinked polymer comprising a network of aryl groups linked by methylene (—CH₂—) bridging groups formed by Friedel-Crafts catalyzed polymerization or Friedel-Crafts catalyzed post-polymerization cross-linking to absorb the liquid into pores of the hypercrosslinked copolymer and form a free-flowing particulate composition, wherein the weight ratio of absorbed liquid to solid porous particles of hypercrosslinked polymer is from 1:1 to 5:1.

20. A method for removing acid gas from a gas mixture, the method comprising contacting the gas mixture with the composition for capture of acid gas according to claim 1 to absorb the acid gas into the absorbed liquid contained in pores of the solid porous particles of hypercrosslinked polymer.

21. The method of claim 20 wherein the gas mixture is selected from the group consisting of combustion flue gas, hydrocarbon gas mixture, emission from cement or steel production, biogas and ambient air.

22. The method of claim 20, comprising:
providing a housing comprising the composition;
passing the gas mixture comprising an acid gas through the housing to absorb the acid gas into the absorbed liquid contained in pores of the solid porous particles of hypercrosslinked polymer;
heating the composition to a temperature sufficient to desorb the acid gas from the solid porous particles; and
flushing the desorbed acid gas from the housing.

23. An acid gas removal apparatus comprising a housing and the composition for capture of acid gas of claim 1, wherein the housing brings the gas mixture comprising acid gas into contact with the solid porous particles of hypercrosslinked polymer to absorb the acid gas into the absorbed liquid contained in pores of the solid porous particles of hypercrosslinked polymer.

24. The acid gas removal apparatus of claim 23 wherein the housing comprises a packed bed or fluidized bed of the solid porous particles of hypercrosslinked polymer.
